(19) United States
(12) Patent Application Publication
(10) Pub. No.: US 2024/0045033 A1
(43) Pub. Date: Feb. 8, 2024

(54) LIDAR ASSEMBLY WITH ROTATING OPTICS

(71) Applicant: LG INNOTEK CO., LTD., Seoul (KR)

(72) Inventors: SCOTT ROSZKO, East Windsor, NJ (US); MARK STERN, Brooklyn, NY (US); WILLIAM MORDARSKI, Colts Neck, NJ (US)

(73) Assignee: LG INNOTEK CO., LTD., Seoul (KR)

(21) Appl. No.: 17/879,386

(22) Filed: Aug. 2, 2022

(51) Int. Cl. G01S 7/481; G01P 3/44; G01S 17/89

(52) U.S. Cl. CPC G01S 7/4817; G01P 3/44; G01S 17/89

(57) ABSTRACT

Disclosed herein are system and method embodiments for projecting a stationary inverted image. For example, the system includes a lidar assembly with an array of detectors that are mounted relative to an axis. A mirror is mounted for rotation about the axis at a first speed with a front surface aligned to intersect the axis to reflect light along the axis and form a reflected image. A prism is mounted for rotation about the axis at a second speed that is less than the first speed, wherein the prism is disposed between the mirror and the array of detectors and configured to receive the reflected image and to project a stationary inverted image onto the array of detectors.

### TECHNICAL FIELD

One or more embodiments relate to a lidar assembly with rotating optics.

### BACKGROUND

A vehicle may include a sensor system to monitor its external environment for obstacle detection and avoidance. The sensor system may include a camera assembly, a radar assembly, and/or a light detection and ranging (lidar) assembly. A lidar assembly includes one or more emitters for transmitting light pulses away from the vehicle, and one or more detectors for receiving the reflected light pulses and providing corresponding sensor data to a controller, which controls one or more vehicle systems e.g., powertrain, braking and steering, based on the sensor data.

The lidar assembly may include a housing with emitters and detectors that rotate about an axis to scan a 360-degree field of view about the vehicle. Such scanning lidar assemblies often require complex mechanisms and strategies to transmit received signals from the surrounding object(s) to a fixed detector. Accordingly, the proposed systems and methods of the present disclosure provide solutions that reduce the complexity and increase the accuracy and efficiency of such sensors.

### SUMMARY

In one embodiment, a lidar assembly is provided with an array of detectors that are mounted relative to an axis. A mirror mounted for rotation about the axis at a first speed with a front surface aligned to intersect the axis to reflect light along the axis and form a reflected image. A prism is mounted for rotation about the axis at a second speed that is less than the first speed, wherein the prism is disposed between the mirror and the array of detectors and configured to receive the reflected image and to project a stationary inverted image onto the array of detectors.

In another embodiment, a method is provided for projecting a stationary inverted image. A mirror is rotated about an axis extending from an array of detectors at a first speed. A light signal is received that is representative of an image at a front surface of the mirror. The image is reflected onto a surface of a prism, the prism being aligned between the mirror and the array of detectors. The prism is rotated about the axis at a second speed such that the prism is configured to project the image onto the array of detectors such that the image remains stationary, the second speed being less than the first speed.

In yet another embodiment, an optical sensor is provided with a base and at least one detector mounted to the base. A first platform is mounted for rotation about an axis at a first speed and longitudinally spaced apart from the base. A mirror is supported by the first platform. The mirror includes a front surface that is aligned to intersect the axis to reflect light along the axis and form a reflected image. A second platform is mounted for rotation about the axis at a second speed, wherein the second speed is less than the first speed. A prism is supported by the second platform and disposed between the mirror and the at least one detector. The prism is configured to receive the reflected image and to provide a stationary inverted image onto the at least one detector.

### BRIEF DESCRIPTION OF THE DRAWINGS

FIG. 1 is a schematic diagram of an exemplary autonomous vehicle (AV) system with a light detection and ranging (“lidar”) assembly, in accordance with aspects of the disclosure.

FIG. 2 is a sectional view of the lidar assembly of FIG. 1, in accordance with aspects of the disclosure.

FIG. 3A is a rear-perspective view of a mirror of the lidar assembly of FIG. 2, illustrating a first object and an image of the first object reflected by the mirror along a longitudinal axis, in accordance with aspects of the disclosure.

FIG. 3B is a top view of a plane extending from the longitudinal axis, in accordance with aspects of the disclosure.

FIG. 4A is a right-side view of the mirror of FIG. 3A, illustrated with the first object and the reflected image of the first object, in accordance with aspects of the disclosure.

FIG. 4B is a top view of the reflected image of FIG. 4A, in accordance with aspects of the disclosure.

FIG. 5A is a front view of the mirror of FIG. 3A, illustrated with a second object and a reflected image of the second object, in accordance with aspects of the disclosure.

FIG. 5B is a top view of the reflected image of FIG. 5A, in accordance with aspects of the disclosure.

FIG. 6A is a left-side view of the mirror of FIG. 3A, illustrated with a third object and a reflected image of the third object, in accordance with aspects of the disclosure.

FIG. 6B is a top view of the reflected image of FIG. 6A, in accordance with aspects of the disclosure.

FIG. 7A is a rear view of the mirror of FIG. 3A, illustrated with a fourth object and a reflected image of the fourth object, in accordance with aspects of the disclosure.

FIG. 7B is a top view of the reflected image of FIG. 7A, in accordance with aspects of the disclosure.

FIG. 8 is a perspective view of the mirror and a prism of the lidar assembly, illustrating a first object and an image of the first object that is reflected by the mirror and inverted by the prism, in accordance with aspects of the disclosure.

FIG. 9A is a right-side view of the mirror and the prism of FIG. 8, illustrated with the first object and the reflected and inverted image of the first object, in accordance with aspects of the disclosure.

FIG. 9B is a front view of the first object, in accordance with aspects of the disclosure.

FIG. 9C is a top view of the reflected image, in accordance with aspects of the disclosure.

FIG. 9D is a top view of the reflected and inverted image, in accordance with aspects of the disclosure.

FIG. 10 is a perspective view of the mirror and a prism of the lidar assembly in a first position, illustrating the first object and an image of the first object that is reflected by the mirror and inverted by the prism, in accordance with aspects of the disclosure.

FIG. 11 is a perspective view of the mirror and the prism of the lidar assembly in a second position, illustrating a second object and an image of the second object that is reflected by the mirror and inverted by the prism, in accordance with aspects of the disclosure.

FIG. 12 is another perspective view of the mirror and the prism of the lidar assembly in a third position, illustrating a third object and an image of the third object that is reflected by the mirror and inverted by the prism, in accordance with aspects of the disclosure.

FIG. 13 is another perspective view of the mirror and the prism of the lidar assembly in a fourth position, illustrating the first object and another image of the first object that is reflected by the mirror and inverted by the prism, in accordance with aspects of the disclosure.

FIG. 14 is a right-side view of the mirror and a second prism of the lidar assembly, according to another embodiment, illustrated with a first object and a reflected and inverted image of the first object, in accordance with aspects of the disclosure.

FIG. 15 is a flow chart illustrating a method for controlling the rotational speed of multiple optics of the lidar assembly to project an inverted stationary image, in accordance with aspects of the disclosure.

FIG. 16 is a detailed schematic diagram of an example computer system for implementing various embodiments, in accordance with aspects of the disclosure.

In the drawings, like reference numbers generally indicate identical or similar elements. Additionally, generally, the left-most digit(s) of a reference number identifies the drawing in which the reference number first appears.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Rotating optical sensors such as mechanical lidars include complex physical and electrical architectures. In some examples, for object detection and ranging, a mechanical lidar may include optical transmitters and receivers in a rotating head that transmit light pulses and receive corresponding returned pulses. Aspects of the present disclosure provide solutions that place emitter and/or detector arrays in a non-rotating base of the lidar assembly to, among other things, reduce lidar assembly complexities and weight, simplify sensor assembly, and improve sensor balance.

According to some aspects, the proposed systems and methods of the present disclosure provide solutions that enable the transmission of a received signal from a rotating lidar to a fixed detector and/or controller using less complex mechanisms and to maintain a stationary image in a scanning lidar assembly that includes a rotating emitter and/or detector. For example, the present disclosure provides an inversion prism that rotates at a different rate than a scanning mirror of the lidar assembly to receive a light pulse signal (indicative of one or more points of a scanned scene, e.g., image), and project the image onto a detector of the lidar sensor with corrected orientation changes. According to some aspects, the proposed systems and methods provide for the ability to receive a correctly oriented image at a detector for all of the 360 degree scanned environment with no blind spots. Moreover, according to some aspects of the disclosure, the correction in orientation changes allows the system to have stationary optical detectors and processing electronics (e.g., positioned at the non-rotating base of the lidar)—thereby simplifying the lidar assembly and associated components. According to some aspects of the disclosure, the present systems and methods also make data transfer and thermal management more efficient due to, in part, the reduction of moving internal components. For example, reducing the number of components housed in the rotating head of the lidar sensor can improve balance, maintenance intervals, reduce wear, reduce weight of the lidar, and reduce power required to rotate the lidar head.

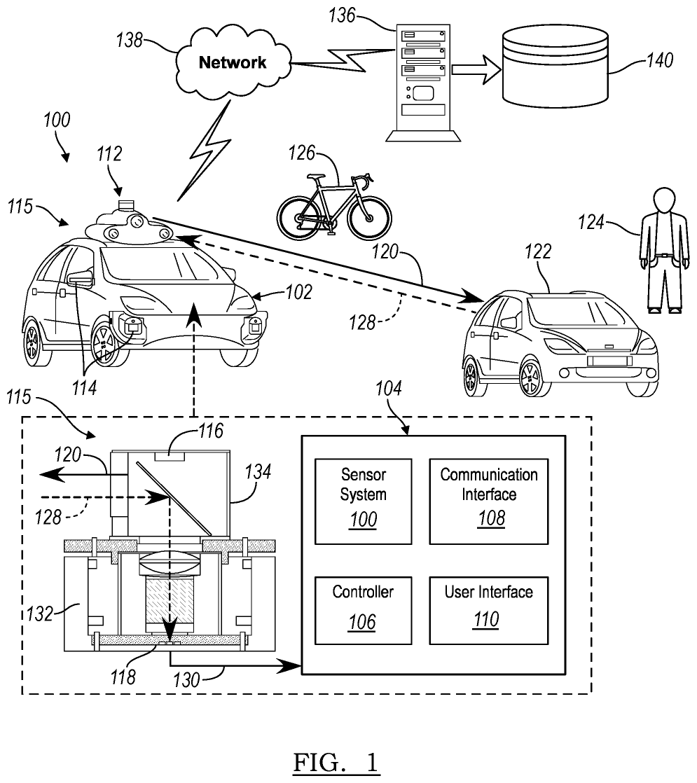

With reference to FIG. 1, a sensor system with multiple rotating optics is illustrated in accordance with one or more embodiments and generally referenced by numeral 100. The sensor system 100 includes multiple sensor assemblies that are mounted to an autonomous vehicle (AV) 102. Each sensor assembly includes one or more optical sensors, such as cameras, lidar sensors, and radar sensors. The sensor system 100 is included in an AV system 104, which also includes a controller 106, a communication interface 108 for communicating with other systems and devices, and a user interface 110 for communicating with a user.

The sensor system 100 includes a top sensor assembly 112 and multiple side sensor assemblies 114 for monitoring the environment external to the AV 102. The top sensor assembly 112 is mounted to a roof of the AV 102 and includes a light detection and ranging (lidar) assembly 115. The lidar assembly 115 includes one or more emitters 116 and one or more detectors 118. The emitters 116 transmit light pulses 120 away from the AV 102. The transmitted light pulses 120 are incident on one or more objects, e.g., a remote vehicle 122, a pedestrian 124, and a cyclist 126, and reflect back toward the top sensor assembly 112 as reflected light pulses 128. The top sensor assembly 112 includes multiple optics to direct the reflected light pulses 128 toward the detectors 118, which provide corresponding signals 130 to the controller 106. The controller 106 processes the signals 130 to determine a distance of each object 122, 124, 126, relative to the AV 102.

The lidar assembly 115 includes a fixed base 132, and a rotating housing 134. The base 132 is mounted to the AV 102, e.g., to a roof of the AV 102. The housing 134 rotates about the longitudinal axis to scan a 360-degree field of view about the AV 102. The emitter 116 is mounted to the rotating housing 134 and the detector 118 is mounted to the fixed base 132, according to the illustrated embodiment. In other embodiments, the detector 118 is mounted to a rotating component, and the emitter 116 is mounted to a fixed component of the lidar assembly (not shown). The lidar assembly 115 includes multiple optics that rotate about the longitudinal axis at different speeds to maintain a stationary projected image at the detector 118.

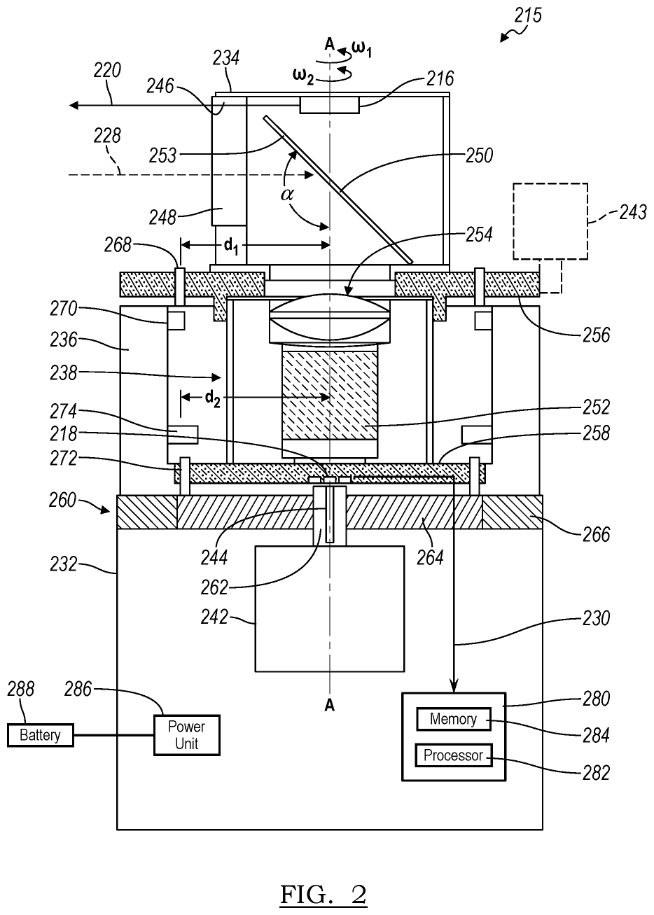

The lidar assembly 215 simplifies sensor data communication and image analysis, as compared to existing scanning lidar units (not shown). Existing scanning lidar assemblies (not shown) often include emitters and detectors that are both mounted to the housing and rotate relative to a fixed base. Such scanning lidar assemblies may require complex mechanisms and implementations for transmitting and processing electrical signals and power between the detector(s) and a controller. The lidar assembly 215 includes a fixed detector 118, according to one or more embodiments. In this regard, having a fixed detector simplifies the design complexities of the lidar assembly 115 because it reduces the need for rotating detectors and associated wiring and implementations for transmitting signals from the rotating detectors to a processor. It can be appreciated that the fixed detector 118 may comprise one or more detector assemblies for detecting received time of flight signals. A scanning lidar unit that includes a rotating emitter and fixed detector may generate a rotating image, which would require complex hardware and/or software to analyze the rotating image. As will be further described herein with reference to FIG. 2, the lidar assembly 215 includes multiple optical elements that rotate at different speeds to collectively project a stationary image onto the detector 218, as described in detail below. As described herein, projecting a stationary image onto a fixed detector significantly reduces the hardware complexities of the lidar assembly 115 as well as software implementations that analyze a rotating image.

The side sensor assemblies 114 include cameras, e.g., visible spectrum cameras, infrared cameras, etc., for monitoring the external environment. In one or more embodiments, the side sensor assemblies 114 also include lidar assemblies to monitor the external environment. The top sensor assembly 112 and the side sensor assemblies 114 may each include other ranging sensors, e.g., radar or sonar sensors.

The AV system 104 may communicate with a remote computing device 136 over a network 138. The remote computing device 136 may include one or more servers to process one or more processes of the technology described herein. The remote computing device 136 may also communicate with a database 140.

FIG. 2 illustrates an exemplary architecture of a lidar assembly 215, such as the lidar assembly 115 of the top sensor assembly 112. The lidar assembly 215 includes one or more emitters 216 and one or more detectors 218. The emitters 216 transmit light pulses 220 away from the lidar assembly 215. The transmitted light pulses 220 are incident on one or more external objects and return to the lidar assembly 215 as reflected light pulses 228. The detectors 218 receive the reflected light pulses 228 and provide corresponding signals 230.

The lidar assembly 215 includes a fixed base 232 and a rotating housing 234, according to one or more embodiments. The base 232 is fixed, e.g., mounted to a roof of the AV 102, as shown in FIG. 1. The lidar assembly 215 includes sidewalls 236 that extend transversely from the base to define a cavity 238. The lidar assembly 215 includes a motor 242 with a shaft 244 that extends along a longitudinal axis A-A. The housing 234 is coupled to the shaft 244 and mounted for rotation relative to the base 232 about Axis A-A. The housing 234 includes an opening 246 and a cover or an aperture 248 that is secured within the opening 246. The aperture 248 is formed of a material that is transparent to light. Although a single aperture 248 is shown in FIG. 2, the lidar assembly 215 may include multiple apertures 248.

The emitter 116 is mounted to the housing 134 and rotates about Axis A-A, according to one or more embodiments. The emitter 216 transmits the light pulses 220 through the aperture 248 that are incident on one or more objects. The emitters 216 may include laser emitter chips or other light emitting devices and may include any number of individual emitters (e.g., eight emitters, sixty-four emitters, or one hundred twenty-eight emitters). The emitters 216 may transmit light pulses 220 of substantially the same intensity or of varying intensities, and in various waveforms, e.g., sinusoidal, square-wave, and sawtooth.

The detectors 218 are mounted to the fixed base 232 and receive the reflected light pulses 228. The detectors 218 also receive light from external light sources, e.g., the sun. The detectors 218 may include a photodetector or an array of photodetectors that are positioned to receive the reflected light pulses 228. In one or more embodiments, the detectors 218 are formed in a linear array.

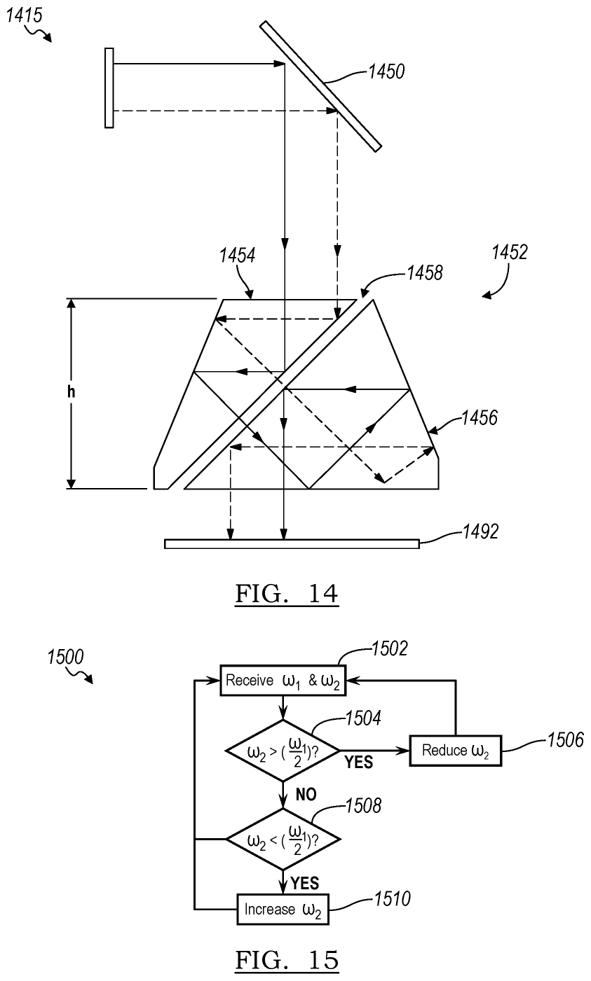

The lidar assembly 215 includes optics, such as a mirror 250 and a prism 252, that direct the reflected light pulses 228 toward the detectors 218. The mirror 250 includes a front surface 253 that intersects Axis A-A at an obtuse angle (a) to receive and reflect the reflected light pulses 228 along Axis A-A toward the detectors 218. The angle (a) may be between 120-150 degrees. In one embodiment, angle (a) is 135 degrees. The prism 252 is arranged along Axis A-A and receives the reflected light from the mirror 250. The prism 252 inverts the reflected light and projects a stationary image onto a focal plane aligned with the detectors 218. The prism 252 is a Dove prism, according to the illustrated embodiment. In other embodiments, the prism 252 is a Pechan prism (see FIG. 14). The lidar assembly 215 may include one or more additional lenses 254 that are disposed between the mirror 250 and the prism 252 to focus and/or collimate the reflected light.

According to some aspects, the mirror 250 and the prism 252 rotate at different speeds about the longitudinal Axis A-A. The housing 234 and the mirror 250 are mounted to a first platform 256 that rotates about Axis A-A at a first rotational speed (ω₁). The prism 252 is mounted to a second platform 258 that rotates about Axis A-A within the cavity 238 at a second rotational speed (ω₂). According to some aspects of the disclosure, in order to consistently maintain the projection image onto the detectors 218 (e.g., in a non-rotated/stationary state), the prism rotational speed may be set to be a fraction of the mirror rotational speed. For example, the prism rotational speed (ω₂) may be half of the mirror rotational speed (ω₁), i.e. ω₂=ω₁/2.

In one embodiment, the motor 242 is coupled to the mirror 250 and the prism 252 by different output ratios to rotate at different speeds. The lidar assembly 215 includes a transmission 260, such as a single-stage planetary gearset, according to one or more embodiments. The transmission 260 includes a sun gear 262, planet gears 264, and a ring gear 266. The sun gear 262 is fixed to the motor shaft 244, and each of the sun gear 262, planet gears 264, and ring gear 266 are connected to one of the base 232, the first platform 256, and the second platform 258 to provide the different gear ratios. In other embodiments, the transmission 260 may include other mechanisms to provide the output ratio, such as helical gears, belts, pulleys, etc. In another embodiment, the lidar assembly 215 independently controls the mirror rotational speed (ω₁) and the prism rotational speed (ω₂) e.g., by coupling the motor 242 to the prism 252 and coupling a second motor 243 to the mirror 250.

The lidar assembly 215 includes sensors to monitor the speed and angular position of the mirror 250 and the prism 252, according to one or more embodiments. In one embodiment, the lidar assembly 215 includes a series of first sensors 268 that are mounted to the first platform 256. The first sensors 268 are radially spaced apart from Axis A-A at a distance (d1), and angularly spaced apart from each other about Axis A-A. The lidar assembly 215 also includes a series of first magnets 270 that are mounted to an upper portion of the sidewalls 236 within the cavity 238 of the base 232. The first magnets 270 are also angularly spaced apart from each other about Axis A-A, and radially spaced apart from Axis A-A at the distance (d1) such that the first sensors 268 monitor the magnetic fields from the first magnets 270 during rotation to generate a signal (ω₁) that represents the position and/or the rotational speed of the mirror 250 that is mounted to the first platform 256.

The lidar assembly 215 may also include a series of second sensors 272 that are mounted to the second platform 258 and a series of second magnets 274 that are mounted to a lower portion of the sidewalls 236 within the cavity 238 of the base 232. The second sensors 272 and the second magnets 274 are radially spaced apart from Axis A-A at a distance (d2), and angularly spaced apart from each other about Axis A-A such that the second sensors 272 monitor the magnetic fields from the second magnets 274 during rotation to generate a signal (ω₂) that represents the position and/or the rotational speed of the prism 252 that is mounted to the second platform 258. In embodiments in which the motor 242 is coupled to the mirror 250 and the prism 252 by a fixed gear ratio, the lidar assembly 215 may include the first sensors 268 and calculate the prism rotational speed (ω₂) or include the second sensors 272 and calculate the mirror rotational speed (ω₁).

The lidar assembly 215 includes a controller 280 with a processor 282 and memory 284 to control various components, e.g., the motor 242, the emitters 216, and the detectors 218. The controller 280 also analyzes the data collected by the detectors 218 and the sensors 268, 272, to measure characteristics of the light received and the speed of the optics, and generates information about the environment external to the AV 102. The lidar assembly 215 also includes a power unit 286 that receives electrical power from a vehicle battery 288, and supplies the electrical power to the motor 242, the emitters 216, the detectors 218, and the controller 280. Although the controller 280 is shown as a single controller, it may contain multiple controllers, or it may be embodied as software code within one or more other controllers, such as the AV controller 106. The controller 280 generally includes any number of microprocessors, ASICs, ICs, memory (e.g., FLASH, ROM, RAM, EPROM and/or EEPROM) and software code to co-act with one another to perform a series of operations. Such hardware and/or software may be grouped together in modules to perform certain functions. Any one or more of the controllers or devices described herein include computer executable instructions that may be compiled or interpreted from computer programs created using a variety of programming languages and/or technologies. In general, a processor, e.g., the processor 282 receives instructions, for example from storage, e.g., the memory 284, a computer-readable medium, or the like, and executes the instructions. A processing unit includes a non-transitory computer-readable storage medium capable of executing instructions of a software program. The computer readable storage medium may be, but is not limited to, an electronic storage device, a magnetic storage device, an optical storage device, an electromagnetic storage device, a semi-conductor storage device, or any suitable combination thereof. The controller 280 also includes predetermined data, or “look up tables” that are stored within the memory, according to one or more embodiments.

Existing scanning lidar assemblies (not shown) often include emitters and detectors that are both mounted to the housing and rotate relative to a fixed base. Such scanning lidar assemblies often require complex mechanisms and strategies to transmit the signal from the detector(s) to a controller. According to some aspects, the lidar assembly 215 reduces this complexity by mounting the emitters 216 or the detectors 218 on the fixed base 232.

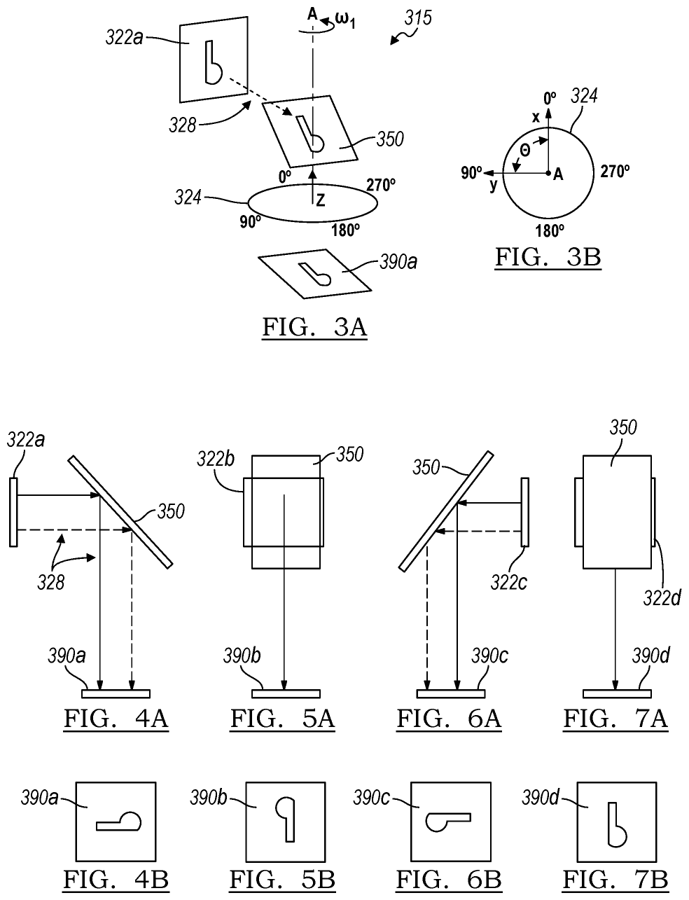

FIGS. 3A-7B are schematic diagrams illustrating how an image is received and reflected by a lidar assembly 315. The lidar assembly 315 includes a mirror 350 that rotates 360 degrees about Axis A-A, like the mirror 250 of the lidar assembly 215. The mirror 350 receives light pulses 328 that reflect off of objects, such as the remote vehicle 122, pedestrian 124, and cyclist 126 shown in FIG. 1. These objects are represented by objects 322a-322d (letter “b”) in FIGS. 3A-7B.

FIGS. 3A and 4A illustrate a first object 322a that is located at an azimuth angle (θ) of zero (0) degrees in a plane 324 extending transversely from Axis A-A. FIG. 5A illustrates a second object 322b that is located at an azimuth angle of ninety degrees (θ=90 degrees). FIG. 6A illustrates a third object 322c that is located at an azimuth angle of 180 degrees, and FIG. 7A illustrates a fourth object 322d that is located at an azimuth angle of 270 degrees. FIG. 3B illustrates a top-view of the lidar coordinate system in the X-Y plane 324. The lidar coordinate system is established from the point of view of the detectors 218 (FIG. 2), i.e. facing upwards toward the plane 324, therefore the azimuth angle in FIG. 3A increases with counter-clockwise rotation.

FIGS. 4A-7B illustrate how the light pulses 328 reflect downward from the mirror 350 to form reflected images 390a-390d. FIGS. 4B, 5B, 6B, and 7B illustrate a top-view of the reflected images 390a, 390b, 390c, and 390d for objects 322a, 322b, 322c, and 322d, respectively. As shown in FIGS. 4B, 5B, 6B, and 7B, the reflected images 390a, 390b, 390c, and 390d rotate counter-clockwise with counter-clockwise rotation of the mirror 350. These rotating images 390a-390d may be difficult for the detectors 218 to monitor and would require additional signal processing to compensate for the different rotations.

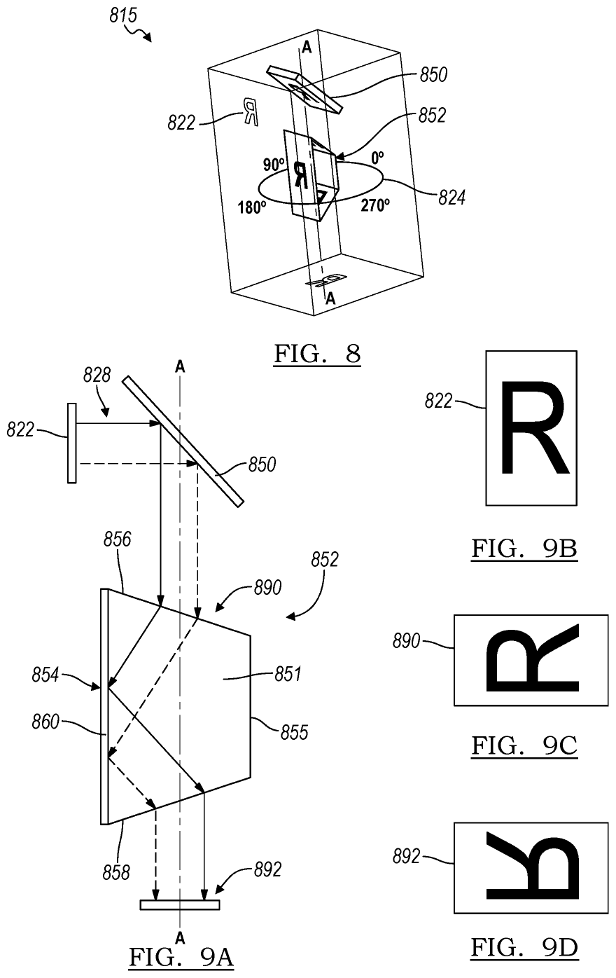

FIGS. 8-9D are schematic diagrams illustrating how an image is received, reflected, and inverted by a lidar assembly 815. The lidar assembly 815 includes a mirror 850 and a prism 852 that rotate 360 degrees about Axis A-A through its field-of-view (FOV), like the mirror 250 and the prism 252 of the lidar assembly 215. The prism 852 is a Dove prism, according to the illustrated embodiment, and formed with a trapezoid cross-section. The prism 852 includes a body 851 that is formed from an optically transparent material, such as optical grade glass. For example, in one embodiment, the body 851 is formed of N-BK7 by Schott, which is a relatively pure universal optical glass for the visible spectrum. The body 851 includes a major face 854 and a minor face 855 that are arranged in parallel with the longitudinal Axis A-A, and in parallel with each other. The major face 854 is longer than the minor face 855. The prism 852 also includes an input face 856 and an output face 858 that extend between the major face 854 and the minor face 855 to intersect Axis A-A. The prism 852 includes a reflective material 860, that is selected based on the detectable wavelength of the receiver, and disposed over the major face 854, according to one or more embodiments.

The mirror 850 receives light pulses 828 that reflect off of objects, which are represented by object 822 (letter “R”). The mirror 850 reflects the light pulses 828 onto the input face 856 of the prism 852 to form a reflected image 890, as shown in FIG. 9C. The light pulses 828 reflect off of the reflective material 860 on the major face 854 and through the output face 858 to form an inverted image 892, as shown in FIG. 9D.

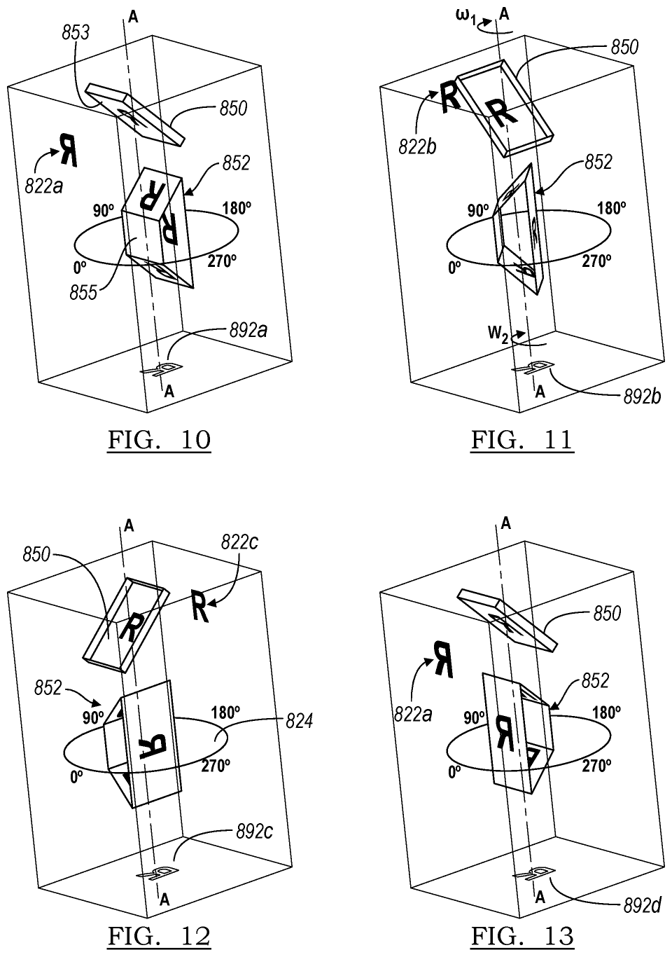

FIGS. 10-13 illustrate perspective views of the mirror and prism of the lidar assembly rotating at different speeds and interacting at different positions, and the corresponding stationary image projected onto the detector plane, in accordance with aspects of the disclosure. The prism 852 is a Dove prism, which inverts the reflected image 890 to form the inverted image 892, as shown in FIGS. 9A-9D. When rotated about the longitudinal Axis A-A, the prism 852 rotates the inverted image 892 at twice the rotation frequency of the prism 852. Therefore, if the mirror 850 and the prism 852 were rotated at the same rotational speed (ω), the inverted image 892 would rotate at twice the rotational speed (i.e., 2ω). However, if the mirror 850 is rotated at a first rotational speed (ω₁), and the prism 852 is rotated at a second rotational speed (ω₂) that is half of the first rotational speed, i.e. ω₂=ω₁/2, then the lidar assembly 815 projects a stationary inverted image 892. The lidar assembly 815 may rotate in either direction about Axis A-A, i.e., clockwise and counter-clockwise. The lidar assembly 815 rotates clockwise in FIGS. 10-13. Here the lidar coordinate system is established from a top view of the detectors 218, therefore the azimuth angle increases with clockwise rotation.

FIG. 10 illustrates a first object 822a, the mirror 850, and the prism 852 all arranged at an azimuth angle (θ) of 0 degrees to project a first inverted image 892a. The mirror 850 is arranged such that its front surface 853 is facing the first object 822a, and the prism 852 is arranged such that its minor face 855 is facing the first object 822a. FIG. 11 illustrates a second object 822b and the mirror 850 arranged at a first azimuth angle (θ₁) of 90 degrees, and the prism 852 arranged at a second azimuth angle (θ₂) of 45 degrees, i.e., θ₂=θ₁/2, to project a second inverted image 892b. FIG. 12 illustrates a third object 822c and the mirror 850 arranged at a first azimuth angle (θ₁) of 180 degrees, and the prism 852 arranged at a second azimuth angle (θ₂) of degrees, i.e., θ₂=θ₁/2 to project a third inverted image 892c.

FIG. 13 again illustrates the first object 822d and the mirror 850 arranged at a first azimuth angle (θ₁) of 360 degrees, and now, the prism 852 is arranged at a second azimuth angle (θ₂) of 180 degrees, i.e., θ₂=θ₁/2. As shown in FIGS. 10-13, by rotating the prism 852 at the second rotational speed (ω₂) that is half of the first rotational speed (ω₁) of the mirror 850, the lidar assembly 815 projects a stationary inverted image 892a-892d.

FIG. 14 illustrates a lidar assembly 1415 with a mirror 1450 and a Pechan prism 1452. Like the Dove prism 852, the Pechan prism 1452, when rotating about the longitudinal Axis A-A (not shown), rotates the projected image at twice the rotation frequency of the prism 1452 to create a stationary image 1492 (e.g., an image that does not rotate with the rotating optics above). The Pechan prism 1452 includes a first prism 1454 and a second prism 1456 that are separated by an air gap 1458. The Pechan prism 1452 has a smaller longitudinal height, as compared to the Dove prism 852, which may be used to reduce the overall height of the housing (shown in FIG. 2) of the lidar assembly 1415.

With reference to FIG. 15, a flow chart depicting a method for controlling the rotational speed of the mirror 250 and the prism 252 is illustrated in accordance with one or more embodiments and is generally referenced by numeral 1500. The lidar assembly 215 provides a stationary projected image by maintaining a prism rotational speed that is approximately equal to half of the mirror rotational speed. The method 1500 is implemented using software code that is executed by the controller 280 of the lidar assembly 215 for embodiments in which the mirror speed (ω₁) and the prism speed (ω₁) are independently controlled and not constrained by a fixed output ratio. While the flowchart is illustrated with a number of sequential steps, one or more steps may be omitted and/or executed in another manner without deviating from the scope and contemplation of the present disclosure.

At step 1502, the controller 280 receives input that is indicative of the rotational speed of the mirror 250 and the rotational speed of the prism 252, e.g., the (ω₁) signal from the first sensors 268 and the (ω₂) signal from the second sensors 272.

At step 1504 the controller 280 compares the prism speed (ω₂) to the mirror speed (ω₁) to determine if the prism 252 is rotating too fast, i.e., if the prism 252 is rotating at greater than half of the rotational speed of the mirror 250, e.g., if ω₂>(ω₁/2)). If the prism 252 is rotating too fast, the controller 280 proceeds to step 1506 and reduces the speed of the prism 252, and then returns to step 1502. If the prism 252 is not rotating too fast, the controller 280 proceeds to step 1508.

At step 1508 the controller 280 compares the prism speed (ω₂) to the mirror speed (ω₁) to determine if the prism 252 is rotating too slow, i.e., the prism 252 is rotating at less than half of the rotational speed of the mirror 250, e.g., if (ω₂<ω₁/2)). If the prism 252 is rotating too slow, the controller 280 proceeds to step 1510 and increases the prism speed (ω₂), and then returns to step 1502. If the controller determines that the prism 252 is not rotating too slow at step 1508, the controller 280 proceeds to step 1502 directly.

As such, the lidar assembly 215 simplifies sensor data communication and image analysis, as compared to existing scanning lidar units (not shown). Existing scanning lidar assemblies (not shown) often include emitters and detectors that are both mounted to the housing and rotate relative to a fixed base. Such scanning lidar assemblies often require complex mechanisms and strategies to transmit electrical signals and power between the detector(s) and a controller. The lidar assembly 215 includes a fixed detector 118, according to one or more embodiments, which allows for transmission of the sensor data from the detector 118 by wired communication. A scanning lidar unit that includes a rotating emitter and fixed detector may generate a rotating image, which would require complex hardware and/or software to analyze the rotating image, as described with reference to FIGS. 3A-7B. The lidar assembly 215 includes a prism 252 that rotates at half the speed of the mirror 250 to project a stationary image onto the detector 218, as described in detail below.

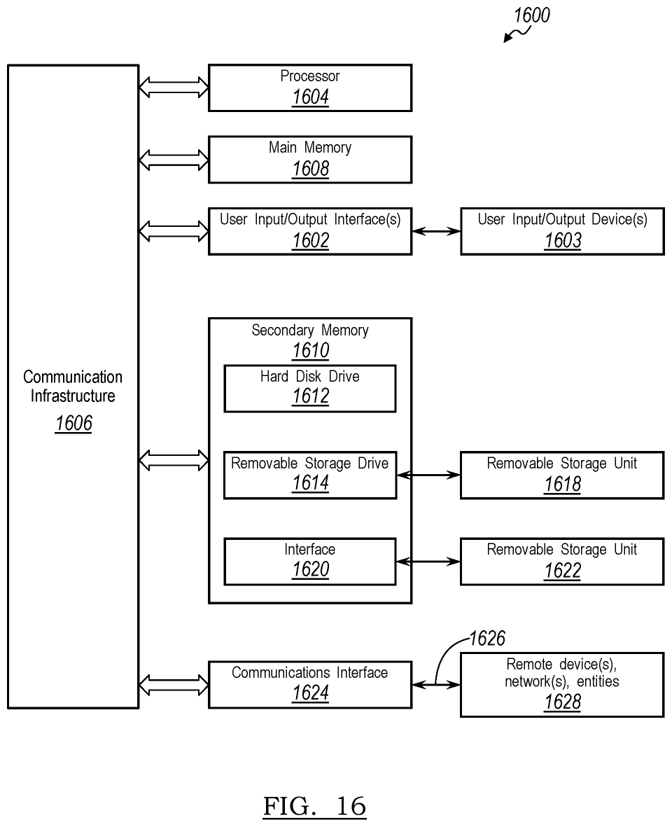

The sensor system 100 may be implemented in an AV system 104, which includes one or more controllers, such as computer system 1600 shown in FIG. 16. The computer system 1600 may be any computer capable of performing the functions described herein. The computer system 1600 also includes user input/output interface(s) 1602 and user input/output device(s) 1603, such as buttons, monitors, keyboards, pointing devices, etc.

The computer system 1600 includes one or more processors (also called central processing units, or CPUs), such as a processor 1604. The processor 1604 is connected to a communication infrastructure or bus 1606. The processor 1604 may be a graphics processing unit (GPU), e.g., a specialized electronic circuit designed to process mathematically intensive applications, with a parallel structure for parallel processing large blocks of data, such as mathematically intensive data common to computer graphics applications, images, videos, etc.

The computer system 1600 also includes a main memory 1608, such as random-access memory (RAM), that includes one or more levels of cache and stored control logic (i.e., computer software) and/or data. The computer system 1600 may also include one or more secondary storage devices or secondary memory 1610, e.g., a hard disk drive 1612; and/or a removable storage device 1614 that may interact with a removable storage unit 1618. The removable storage device 1614 and the removable storage unit 1618 may be a floppy disk drive, a magnetic tape drive, a compact disk drive, an optical storage device, tape backup device, and/or any other storage device/drive.

The secondary memory 1610 may include other means, instrumentalities or other approaches for allowing computer programs and/or other instructions and/or data to be accessed by computer system 1600, e.g., an interface 1620 and a removable storage unit 1622, e.g., a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

The computer system 1600 may further include a network or communication interface 1624 to communicate and interact with any combination of remote devices, remote networks, remote entities, etc. (individually and collectively referenced by reference number 1628). For example, the communication interface 1624 may allow the computer system 1600 to communicate with remote devices 1628 over a communication path 1626, which may be wired and/or wireless, and which may include any combination of LANs, WANs, the Internet, etc. The control logic and/or data may be transmitted to and from computer system 1600 via communication path 1626.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, the computer system 1600, the main memory 1608, the secondary memory 1610, and the removable storage units 1618 and 1622, as well as tangible articles of manufacture embodying any combination of the foregoing. Such control logic, when executed by one or more data processing devices (such as the computer system 1600), causes such data processing devices to operate as described herein.

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” (or “AV”) is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. Notably, the present solution is being described herein in the context of an autonomous vehicle. However, the present solution is not limited to autonomous vehicle applications. The present solution may be used in other applications such as robotic applications, radar system applications, metric applications, and/or system performance applications.

Based on the teachings contained in this disclosure, it will be apparent to persons skilled in the relevant art(s) how to make and use embodiments of this disclosure using data processing devices, computer systems and/or computer architectures other than that shown in FIG. 16. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other. The breadth and scope of this disclosure should not be limited by any of the above-described exemplary embodiments, but should be defined only in accordance with the following claims and their equivalents.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments.

What is claimed is:

1. A lidar assembly comprising:
an array of detectors mounted relative to an axis;
a mirror mounted for rotation about the axis at a first speed, with a front surface aligned to intersect the axis to reflect light along the axis and form a reflected image; and
a prism mounted for rotation about the axis at a second speed that is less than the first speed, wherein the prism is disposed between the mirror and the array of detectors and configured to receive the reflected image and to project a stationary inverted image onto the array of detectors.

2. The lidar assembly of claim 1, wherein the second speed is one half of the first speed.

3. The lidar assembly of claim 1, wherein the prism further comprises:
a major face arranged in parallel with the axis;
a minor face arranged in parallel with the major face, wherein the minor face is shorter than the major face; and
an input face and an output face extending from opposing ends of the major face to opposing ends of the minor face, wherein the input face receives the reflected image and the stationary inverted image exits through the output face.

4. The lidar assembly of claim 3, wherein the prism further comprises:
reflective material disposed over the major face; and
wherein the reflected image reflects off of the reflective material disposed over the major face of the prism and passes through the output face to provide the stationary inverted image.

5. The lidar assembly of claim 1 further comprising:
a motor; and
a transmission coupled between the motor and the mirror at a first output ratio and coupled between the motor and the prism at a second output ratio, wherein the first output ratio is greater than the second output ratio.

6. The lidar assembly of claim 1 further comprising:
at least one motor coupled to the mirror and to the prism; and
at least one sensor to provide a speed signal indicative of at least one of the first speed and the second speed; and
a controller in communication with the at least one motor and programmed to control at least one of the first speed and the second speed based on the speed signal.

7. The lidar assembly of claim 1, wherein the array of detectors is stationary and does not rotate relative to the axis.

8. The lidar assembly of claim 1 further comprising:
a base, wherein the array of detectors is mounted to the base;
a first platform longitudinally spaced apart from the base and mounted for rotation about the axis at the first speed, wherein the first platform supports the mirror;
sidewalls extending transversely from the base to the first platform to define a cavity; and
a second platform disposed within the cavity and mounted for rotation about the axis at the second speed, wherein the second platform supports the prism.

9. The lidar assembly of claim 8 further comprising:
a first magnet mounted to one of the sidewalls and the first platform; and
a first sensor mounted to the other of the sidewalls and the first platform to detect the first magnet to provide a mirror rotational speed signal indicative of the first speed.

10. The lidar assembly of claim 9 further comprising:
at least one motor coupled to the first platform and the second platform;
a second magnet mounted to one of the sidewalls and the second platform;
a second sensor mounted to the other of the sidewalls and the second platform to detect the second magnet to provide a prism rotational speed signal indicative of the second speed; and
a controller in communication with the at least one motor and programmed to control one of the first speed and the second speed based on the other of the first speed and the second speed.

11. The lidar assembly of claim 10, wherein the controller is further programmed to decrease the second speed in response to the second speed being greater than one half of the first speed.

12. The lidar assembly of claim 10, wherein the controller is further programmed to increase the second speed in response to the second speed being less than one half of the first speed.

13. A method for projecting a stationary inverted image comprising:
rotating a mirror about an axis extending from an array of detectors at a first speed;
receiving a light signal representative of an image at a front surface of the mirror;
reflecting the image onto a surface of a prism, the prism being aligned between the mirror and the array of detectors; and
rotating the prism about the axis at a second speed such that the prism is configured to project the image onto the array of detectors such that the image remains stationary, the second speed being less than the first speed.

14. The method of claim 13 further comprising:
controlling one of the first speed and the second speed based on the other of the first speed and the second speed.

15. The method of claim 13 further comprising:
decreasing the second speed in response to the second speed being greater than one half of the first speed.

16. The method of claim 13 further comprising:
increasing the second speed in response to the second speed being less than one half of the first speed.

17. An optical sensor comprising:
a base;
at least one detector mounted to the base;
a first platform mounted for rotation about an axis at a first speed and longitudinally spaced apart from the base;
a mirror supported by the first platform, the mirror comprising a front surface aligned to intersect the axis to reflect light along the axis and form a reflected image;
a second platform mounted for rotation about the axis at a second speed, wherein the second speed is less than the first speed; and
a prism supported by the second platform and disposed between the mirror and the at least one detector, the prism being configured to receive the reflected image and to provide a stationary inverted image onto the at least one detector.

18. The optical sensor of claim 17 further comprising:
a motor; and
a transmission coupled between the motor and the mirror at a first output ratio and coupled between the motor and the prism at a second output ratio, wherein the first output ratio is greater than the second output ratio.

19. The optical sensor of claim 17 further comprising:
at least one motor coupled to the mirror and to the prism; and
at least one sensor to provide a speed signal indicative of at least one of the first speed and the second speed; and
a controller in communication with the at least one motor and programmed to control at least one of the first speed and the second speed based on the speed signal.

20. The optical sensor of claim 17 further comprising at least one emitter to project light pulses radially outward from the axis, wherein the mirror receives light indicative of the light pulses reflected off an external object.
